(19) United States
(12) Patent Application Publication
(10) Pub. No.: US 2003/0131957 A1
(43) Pub. Date: Jul. 17, 2003

(54) Treatment of pulp to produce microcrystalline cellulose

(76) Inventors: David Schaible, Gardiner, NY (US); Bob Sherwood, Amenia, NY (US)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/301,526

(22) Filed: Nov. 20, 2002

Related U.S. Application Data
(63) Continuation of application No. 09/609,583, filed on Jun. 30, 2000, now abandoned.
(60) Provisional application No. 60/142,222, filed on Jul. 2, 1999.

(51) Int. Cl. D21C 3/00; D21C 3/20; C08B 1/00; C08B 11/00

(52) U.S. Cl. 162/65; 162/72; 162/78; 162/76; 536/56; 536/84; 536/120; 536/126

(57) ABSTRACT

In one embodiment of the invention is disclosed a process for the production of microcrystalline cellulose comprising

hydrolyzing pulp with a sufficient amount of active oxygen in an acidic environment in a one step process; and

recovering the microcrystalline cellulose;

wherein said recovered microcrystalline cellulose has a color lightness (L*) greater than the color lightness (L*) of the pulp starting material.

This application claims the benefit of Provisional Application Serial No. 60/042,222 filed Jul. 2, 1999, the disclosure of which is hereby incorporated by reference.

### BACKGROUND OF THE INVENTION

Microcrystalline cellulose, a processed cellulose, has been utilized extensively in the pharmaceutical, food and paper industries.

In the pharmaceutical industry, microcrystalline cellulose can be used as a direct compression vehicle for solid dosage forms and is commercially available under the trade name EMCOCEL® from Penwest Pharmaceuticals Co. Compared to other directly compressible excipients, microcrystalline cellulose is generally considered to exhibit superior compressibility and disintegration properties.

In the food industry, microcrystalline cellulose can be used as a stabilizer, texturizing agent, and fat replacer. It is used in many products such as reduced-fat salad dressings, dairy products' including cheese, frozen desserts and whipped toppings, and bakery products.

Traditionally, microcrystalline cellulose is manufactured by hydrolyzing dissolving grade woodpulp with mineral acids. For example, woodpulps in the range of 92%-98% alpha cellulose content with a brightness level of 92-95 (iso) are typically used as starting material. In a typical reaction, the woodpulp is subjected to an acid solution under heat and pressure. The cellulose polymers in the pulp are reduced to small chain polymers or microcrystals. The resulting microcrystalline cellulose is at least 98% alpha cellulose and has the same brightness level as the starting raw material. The microcrystalline cellulose is then washed and dried prior to packaging.

U.S. Pat. No. 5,769,934 describes a method for producing microcrystalline cellulose by subjecting a cellulose source material to steam explosion treatment, extracting the steam treated cellulosic material to remove hemicelluldse and lignin, and recovering microcrystalline cellulose that is described as substantially colloidal in particle size and essentially free of fibrous cellulose.

U.S. Pat. No. 4,745,058 describes a method for producing microcrystalline cellulose comprising the steps of generating cellulose fibers by placing a cellulose fiber producing bacteria of the genus Acetobacter in a growing medium. The cellulose fibrils produced by the bacteria are then removed from the medium and excess medium is removed from the fibrils. The fibrils are then immersed in an aqueous solution of a base for a predetermined period of time after which the fibrils are neutralized by immersing the fibrils in an acidic solution. The fibrils are thereafter subjected to a treatment with a hot strong acid and are disintegrated to produce microcrystalline cellulose.

In such prior art methods of microcrystalline cellulose production, the cellulose starting material (e.g. wood pulp) can be bleached and whitened by treatment with peroxy acids at a high pH. This preliminary bleaching step of the pulp prior to hydrolysis provides a final microcrystalline cellulose product which has increased brightness.

U.S. Pat. No. 4,756,800, teaches that pulp can be bleached by monoperoxysulfuric acid salts in an alkaline reaction mixture that comprises cupric ions. The patent teaches that the reaction should take place at a pH maintained at from about 12 to about 12.9.

Alternatively, the final microcrystalline cellulose product can be bleached and cleaned after the hydrolysis step. For example, U.S. Pat. No. 3,954,727 describes a method of producing microcrystalline cellulose by acid hydrolyzing a cellulose containing material and de-aggregating the resulting crystalline mass, the acid hydrolysis being performed at the same time as the chemical de-aggregating of the material. The de-aggregated material is then bleached and cleaned, preferably by a peroxy acid in a separate step.

There is a need for a method of producing microcrystalline cellulose from a variety of pulp grades which eliminates the need to perform multiple steps with respect to hydrolysis and bleaching to achieve a satisfactory product. Such a method would ideally perform the hydrolysis and bleaching of the pulp in a one-step process and would provide a high grade microcrystalline cellulose product without regard to the grade of the pulp starting material.

### SUMMARY OF THE INVENTION

It is an object of the invention to provide a novel method for the manufacture of microcrystalline cellulose.

It is another object of the invention to provide a method of producing microcrystalline cellulose from a variety of pulp grades.

It is another object of the invention to provide a method of producing high brightness microcrystalline cellulose utilizing low brightness pulps as starting materials.

It is another object of the invention to provide a method for producing microcrystalline cellulose utilizing active oxygen in an acidic environment for hydrolyzing/bleaching pulp.

It is another object of the invention to provide a method for producing microcrystalline cellulose utilizing a peroxy acid for hydrolyzing/bleaching pulp.

It is a further object of the invention to utilize active oxygen in an acidic environment to hydrolyze cellulose down to the level off degree of polymerization, or into microcrystalline cellulose with a degree of polymerization below about 350.

It is a further object of the invention to utilize active oxygen in an acidic environment to hydrolyze cellulose down to the level off degree of polymerization, or into microcrystalline cellulose with a degree of polymerization below about 250.

It is a further object of the invention to utilize peroxy acids to hydrolyze cellulose down to the level off degree of polymerization, or into microcrystalline cellulose with a degree of polymerization below about 350.

It is a further object of the invention to utilize peroxy acids to hydrolyze cellulose down to the level off degree of polymerization, or into microcrystalline cellulose with a degree of polymerization below about 250.

It is another object of the invention to provide a method of microcrystalline cellulose production wherein said recovered microcrystalline cellulose has a color lightness (L*) greater than the color lightness (L*) of the pulp starting material.

It is another object of the invention to provide microcrystalline cellulose with a green to red color value (a) closer to 0 than the green to red color value (a) of the pulp starting material.

It is another object of the invention to provide microcrystalline cellulose with a blue to yellow color value (b) closer to 0 than the blue to yellow color value (b) of the pulp starting material.

It is another object of the invention to provide a method of producing a high brightness microcrystalline cellulose, preferably with a color lightness (L*) of greater than about 90, more preferably greater than about 95, utilizing low grade pulp as a starting material.

It is another object of the invention to provide microcrystalline cellulose with a color lightness (L*) greater than about 90 utilizing pulp with a color lightness (L*) of less than about 70.

It is another object of the invention to provide microcrystalline cellulose with a color lightness (L*) greater than about 85 utilizing pulp with a color lightness (L*) of less than about 80.

It is another object of the invention to provide a method of producing a high brightness microcrystalline cellulose with a preferable green to red color value (a) of between about −1 to about 1, more preferably between about −0.5 to about 0.5, utilizing low grade pulp as a starting material.

It is another object of the invention to provide microcrystalline cellulose with a green to red color value (a) between −0.5 and 0.5, utilizing pulp with a green to red color value (a) greater than about 1.

It is another object of the invention to provide microcrystalline cellulose with a green to red color value (a) between −1 and 1, utilizing pulp with a green to red color value (a) greater than about 2.

It is another object of the invention to provide a method of producing a high brightness microcrystalline cellulose with a preferable blue to yellow color value (b) of between about −5 to about 5, more preferably between about −2.5 to about 2.5, utilizing low grade pulp as a starting material.

It is another object of the invention to provide microcrystalline cellulose with a blue to yellow color value (b) less than about 10, utilizing pulp with a blue to yellow color value (b) greater than about 10.

It is another object of the invention to provide microcrystalline cellulose with a blue to yellow color value (b) between about −5 and 5, utilizing pulp with a blue to yellow color value (b) greater than about 10.

It is another object of the invention to provide microcrystalline cellulose with a blue to yellow color value (b) between about −2.5 and 2.5, utilizing pulp with a blue to yellow color value (b) greater than about 10.

It is another object of the invention to provide a method of microcrystalline cellulose production which utilizes low grade pulp as starting material, and provides a final product comparable to that produced using high brightness pulps as starting materials.

It is another object of the invention to provide a composition comprising microcrystalline cellulose produced in accordance with the methods disclosed herein.

These objects and other objects of the invention are achieved by virtue of the present invention, which in one embodiment, provides a method of producing microcrystalline cellulose utilizing active oxygen in an acidic environment to bleaching and hydrolyze pulp in a one-step process.

### DETAILED DESCRIPTION OF THE INVENTION

For the purposes of the present invention, the term “pulp” refers to any fibrous cellulosic material formed from wood or any other plant material. The material can be formed by any procedure known in the art such as chemical digestion processes (e.g. sulfite, soda or organosolv processes), thermo-mechanical processes (e.g. steam explosion) and mechanical processes (e.g. grinding).

The pulp starting material can be any grade and can have an initial color lightness (L*) value of less than 70, less than 80, less than 90 and less than about 93. Examples of suitable starting materials unbleached kraft pulp (utilized in the production of cardboard), fluff pulp or Northern Bleached Softwood Krat.

For purposes of the invention, a “one-step process” is meant to be inclusive of hydrolysis and bleaching, and is not meant to include any related preliminary or subsequent steps.

For the purposes of the present invention, the term “color lightness (L*)” refers to the color lightness dimension of the brightness measurement as quantified by a calorimeter, e.g., a Minolta® Chroma Meter®. The specified value is from 0-100, the lighter the color, the larger the L* value.

For the purposes of the present invention, the term “green to red color value (a)” refers to the green to red dimension of the brightness measurement as quantified by a calorimeter such as a Minolta Chroma Meter. The green color has a negative value (0 to −60), and the red color has a positive value (0 to 60).

For the purposes of the present invention, the term “blue to yellow color value (a)” refers to the blue to yellow dimension of the brightness measurement as quantified by calorimeter. The blue color has a negative value (0 to −60), and the yellow color has a positive value (0 to 60).

According to the above definitions, absolute white color should have an L*ab value as 100-0-0.

In certain embodiments of the invention, there is provided a process for the production of microcrystalline cellulose comprising hydrolyzing pulp with a sufficient amount of active oxygen in an acidic environment in a one step process and recovering the microcrystalline cellulose, wherein the microcrystalline cellulose has a color lightness (L*) greater than the color lightness (L*) of the pulp starting material. This process is reacted in a sufficient amount of a suitable reagent medium, preferably an aqueous medium, e.g., H₂O.

The active oxygen can also be derived from other sources known to those skilled in the art such as oxygen, ozone, organic peroxides, hydroperoxides, peroxyacids, peroxyesters and mixtures thereof. This list is not meant to be exclusive. Specific agents which are suitable for providing active oxygen in the present invention include benzoyl peroxide, oxaloyl peroxide, lauroyl peroxide, acetyl peroxide, t-butyl peroxide, t-butyl peracetate, t-butyl peroxy pivalate, cumene hydroperoxide, dicumyl peroxide, 2-methyl pentanoyl peroxide, hydrogen peroxide and mixtures thereof.

In preferred embodiments, the active oxygen and the acid environment are both provided by a suitable active oxygen compound e.g. a peroxy acid. However, a further acid can be introduced into the medium such as a mineral acid, an organic acid or a combination thereof e.g., hydrochloric acid or acetic acid. The acidic conditions are preferably less than a pH of about 5.

Peroxy acids which can be used in the present invention also include peroxy acid salts such as the alkali metal salts of peroxymonosulfuric acid, which acid is commonly known as caro's acid. OXONE® is a commercially available product that is derived from KOH neutralization of a caro's acid mixture. OXONE® contains approximately 49% potassium peroxymonosulfate per unit of charge. Other useful salts include ammonium peroxydisulfate, potassium peroxydisulfate, sodium peroxymonocarbonate, potassium peroxydiphosphate, potassium peroxydicarbonate, salts of peroxymonophosphoric acid, potassium peroxydiphosphoric acid, peroxyoxalic acid, peroxytitanic acid, peroxydistannic acid, peroxydigermanic acid, peroxychromic acid, peroxy formic acid, peroxy benzoic acid and peroxy acetic acid.

Alternatively, the peroxy acid can be produced in the reaction medium by reacting a sufficient amount of an acid with a sufficient amount of a peroxide and adding this reactant to a sufficient amount of a reaction solvent, e.g. an aqueous solvent such as H₂O. The acid can be selected from the group consisting of a mineral acid, an organic acid and combinations thereof The mineral acid can include hydrochloric acid, sulfuric acid, phosphoric acid, boric acid, nitric acid and mixtures thereof The organic acid can be a carboxylic acid e.g., acetic acid, formic acid, oxalic acid and combinations thereof The peroxide can be e.g. hydrogen peroxide. In this embodiment, it is preferable to drip the acid into the peroxide. The peroxide can be pure or can be a diluted solution.

If a diluted solution of peroxide is used, it is preferably at least 50% peroxide as the production of the peroxy acid is negatively affected by increasing the dilution of the peroxide. This is evident by example 9, wherein sulfuric acid and hydrogen peroxide were added to the H₂O without performing the drip procedure discussed above. This method had decreased production of peroxy acid and resulted in a decrease in the brightness of the final product.

The final reaction medium will contain an effective amount of active oxygen and an effective amount of acid to bleach/hydrolyze the pulp to produce microcrystalline cellulose in accordance with the invention. Further optimization of the ratio of active oxygen and acid to solid material can be readily ascertained by one skilled in the art in view of the appended examples.

The hydrolysis and bleaching of the pulp with peroxy acids under an acidic pH can be optimized by performing the reaction under heated temperatures, for example, but not limited to, boiling temperatures. The reaction can also optionally be performed under increased pressure. The optimum heated and pressurized conditions can be ascertained by one skilled in the art.

The following examples are for illustrative purposes only and are not meant to Limit the claims in any way. With respect to the examples, it would be readily understood to one skilled in the art that L*ab values can have variance based on control factors, e.g. whether the microcrystalline cellulose is compressed into a tablet, the hardness of the tablet and whether the reading is taken from the sheet form of the pulp or the dried cake form of the microcrystalline cellulose.

Unless otherwise noted, the pulp staring material is in sheet form and the final product is in dried cake form. The L*ab values can therefore have variance based on these distinct physical forms.

### EXAMPLE 1

### Peroxysulfuric Acid Bleaching and Hydrolysis of Fluff Pulp

The first experiment for persufluric acid bleaching and hydrolysis was carried out on fluff pulp, the conditions were: 40 g pulp, +3 L 2N H₂SO₄, +10 g Oxzone, boiling for 90 minutes. Meanwhile, fluff pulp was also hydrolysed with 2 N HCl at the same conditions. After hydrolysis, cellulose was filtered out, washed with hot water, then it was freeze-dried.

The hydrolyzed cellulose was pressed into a tablet, and the brightness measurement was carried out with a Chroma Meter. The L*ab value for peroxysulfuric acid hydrolyzed fluff pulp and HCl hydrolysed fluff pulp is shown in the following table. Apparently, peroxysulfuric acid hydrolysis increased the brightness of the cellulose.

DCM extractive: The hydrolyzed fluff pulp was extracted with dichloromethane, the amount of extractive was determined gravometrically, and the data are shown in the following table.

TABLE 1
Color measurement of hydrolyzed fluff pulp

| Color | HCI | Oxone | Emcocel | Emocel |
|---|---|---|---|---|
| parameters | hydrolyzed | bleached | 50 M | 90 M |
| *L | 94.38 | 98.63 | 98.30 | 97.87 |
| a | 0.72 | −0.32 | −0.32 | −0.19 |
| b | 2.81 | 2.46 | 2.31 | 3.05 |
| DCM | 0.08% | 0.07% | / | / |
| extractive | | | | |

### EXAMPLE 2

### Peroxysulfuric Acid Bleaching and Hydrolysis of Unbleached Kraft Pulp

Unbleached Kraft pulp of southern pine was hydrolyzed respectively with 2 N HCl and [2 N H2SO4+0.2 M Oxone] at boiling temperature for 90 minutes, followed by 1% NaOH extraction at boiling temperature for 60 minutes, the products were filtered out and washed with hot waster, then freeze-dried. Brightness measurement was carried as described above, and the data are shown in the following table.

TABLE 2
Color measurement of hydrolyzed unbleached Kraft pulp

| Color | HCL | H₂SO₄ + | | |
|---|---|---|---|---|
| Parameters | hydrolysis | Oxone | Emcocel 50 M | Emcocel 90 M |
| L* | 70.84 | 96.46 | 98.30 | 97.87 |
| a | 5.19 | 0.39 | −0.32 | −0.19 |
| b | 16.87 | 1.92 | 2.31 | 3.05 |
| Yield | | 58% | | |

The data show that unbleached Kraft pulp, after hydrolysis with [H₂SO₄+Oxone], and extraction with 1% NaOH, its brightness is very close to commercial microcrystalline cellulose products. This suggests that microcrystalline cellulose may be produced directly from cheap unbleached Kraft pulp or other unbleached pulp.

In the above experiment, peroxysulfuric acid was generated from a monoperoxysulfate compound Oxone, and the cost may be high. Therefore, a more commercially feasible way to generate peroxysulfuric acid, that is through the reaction of H₂O₂, concentrated sulfuric acid was tested. 30 ml 70% H₂O₂, was cooled in an ice-water bath, then 72 ml concentrated sulfuric acid (96%) was added and mixed well in an ice-water bath. The mixture was diluted to 1 L before it was used for pulp hydrolysis, and unbleached Kraft pulp of southern pine was hydrolyzed for 90 minutes at boiling temperature, followed by 1% NaOH extraction, and freeze-drying. The brightness of the product was measured and its value is: L*−96.72, a=0.38, b=1.94, which is very close to the brightness of commercial microcrystalline cellulose products.

### EXAMPLE 3

Bleached kraft pulp with a starting degree of polymerization of 1407 was hydrolyzed with hydrochloric acid and peroxymonosulfuric acid in separate experiments and the results were compared. The resulting degree of polymerization for the microcrystalline cellulose hydrolyzed by hydrochloric acid was 224 and the degree of polymerization for the microcrystalline cellulose hydrolyzed by the peroxy acid was 218. These values were obtained using the 90 minute hydrolysis conditions of the above examples.

### EXAMPLE 4

A one step hydrolysis and bleaching of wood pulp was performed on raw unbleached wood pulp having a L*ab value of 67.2-5.7-19.5.

Sulfuric acid, 72 ml, was dripped into 42 ml of 50% H₂O₂ to form the peroxy acid. H₂O was then admixed with this reactant quantum sufficum to 1 liter. The pulp was introduced followed by a reaction time of 2 hours at ambient pressure at 100° C. The resultant microcrystalline cellulose was then filtered and washed with deionized water. The resultant cellulose cake was then added to a 70° C. sodium hydroxide solution. The cellulose was again filtered and washed with deionized water and dried at ambient temperatures.

The cellulose exhibited the following characteristics:

Degree of Polymerization:

245

L*ab(measured with a Minolta CR-321 Chroma meter)

91-0.43-6.5.

### EXAMPLE 5

A one step hydrolysis and bleaching of wood pulp was performed on raw unbleached wood pulp having a L*ab value of 67.2-5.7-19.5.

Sulfuric acid, 72 ml, was dripped into 42 ml of 50% H₂O₂ to form the peroxy acid. H₂O was then admixed with this reactant quantum sufficum to 1 liter. The pulp was introduced followed by a reaction time of 2 hours at ambient pressure at 100° C. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

248

L*ab(measured with a Minolta CR-321 chroma meter)

91-0.53-6.1.

### EXAMPLE 6

A one step hydrolysis and bleaching of wood pulp was performed on raw unbleached wood pulp having a L*ab value of 67.2-5.7-19.5.

A mixture of 63 ml of sulfuric acid and 24 ml acetic acid was dripped into 27 ml of 50% H₂O₂ to form the peroxy acid. H₂O was then admixed with this reactant quantum sufficum to 1 liter. The pulp was introduced followed by a reaction time of 2 hours at ambient pressure at 100° C. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

257

L*ab(measured with a Minolta CR-321 Chroma meter)

85-1.6-13.5

### EXAMPLE 7

A one step hydrolysis and bleaching of wood pulp was performed on raw unbleached wood pulp having a L*ab value of 67.2-5.7-19.5.

36 ml of sulfuric acid was dripped into 21 ml of 50% H₂O₂ to form the peroxy acid. H₂O was then admixed with this reactant quantum sufficum to 1 liter. The pulp was introduced followed by a reaction time of 2 hours at ambient pressure at 100° C. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

266

L*ab(measured with a Minolta CR-321 Chroma meter)

86.5-1.3-10.2

### EXAMPLE 8

A one step hydrolysis and bleaching of wood pulp was performed on raw unbleached wood pulp having a L*ab value of 67.2-5.7-19.5.

H₂O was admixed with 72 ml of sulfuric acid quantum sufficum to 1 liter. The pulp was introduced followed by a reaction time of 2 hours at ambient pressure at 100° C. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

291

L*ab(measured with a Minolta CR-321 Chroma meter)

68.8-5.5-20.2

This experiment did not have any peroxy acid or oxygen content and demonstrates that the active oxygen content is necessary for bleaching.

### EXAMPLE 9

A one step hydrolysis and bleaching of wood pulp was performed on raw unbleached wood pulp having a L*ab value of 67.2-5.7-19.5.

Sulfuric acid, 72 ml, and 42 ml of 50% were admixed with H₂O₂ quantum sufficum to 1 liter. This resulted in a mixture without significant production of peroxy acid. The pulp was introduced followed by a reaction time of 2 hours at ambient pressure at 100° C. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

222

L*ab(measured with a Minolta CR-321 Chroma meter)

87.5-1.3-9.1

### EXAMPLE 10

A one step hydrolysis and bleaching of wood pulp was performed on raw unbleached wood pulp having a L*ab value of 67.2-5.7-19.5.

Sulfuric acid, 72 ml, was dripped into 21 ml of 50% H₂O₂ to form the peroxy acid. 51 ml acetic acid was then dripped into this reactant. H₂O was then added to this reactant quantum sufficum to 1 liter. The pulp was introduced followed by a reaction time of 2 hours at ambient pressure at 100° C. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

240

L*ab(measured with a Minolta CR-321 Chroma meter)

92.9-0.48-4.1

### EXAMPLE 11

A one step hydrolysis and bleaching of wood pulp was performed on raw unbleached wood pulp having a L*ab value of 67.2-5.7-19.5.

H₂O was admixed with 170 ml hydrochloric acid quantum sufficum to 1 liter. The pulp was introduced followed by a reaction time of 3 hours at ambient pressure at 100° C. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

223

L*ab(measured with a Minolta CR-321 Chroma meter)

69.2-5.7-19.5

This experiment further demonstrates that active oxygen is necessary for bleaching.

### EXAMPLE 12

A one step hydrolysis and bleaching of wood pulp was performed on raw unbleached wood pulp having a L*ab value of 67.2-5.7-19.5.

42 ml of 50% H₂O₂ was added to 170 ml hydrochloric acid. H₂O was then admixed with this mixture quantum sufficum to 1 liter. The pulp was introduced followed by a reaction time of 2 hours at ambient pressure at 100° C. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

243

L*ab(measured with a Minolta CR-321 Chroma meter)

76.4-3.9-15.9.

In this experiment, although there was no peroxy acid synthesis, the active oxygen provided by the H₂O₂ bleached the cellulose.

### EXAMPLE 13

A one step hydrolysis and bleaching of wood pulp was performed on raw unbleached wood pulp having a L*ab value of 67.2-5.7-19.5.

Sulfuric acid, 72 ml was dripped into 42 ml of 50% H₂O₂ to form the peroxy acid. Acetic acid, 25 ml, was dripped into this reactant. H₂O was then admixed with this reactant quantum sufficum to 1 liter. The pulp was introduced followed by a reaction time of 2 hours at ambient pressure at 100° C. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

248

L*ab(measured with a Minolta CR-321 Chroma meter)

91.3-0.37-4.1

### EXAMPLE 14

A one step hydrolysis and bleaching of wood pulp was performed on raw unbleached wood pulp having a L*ab value of 67.2-5.7-19.5.

Sulfuric acid, 72 ml, was dripped into 42 ml of 50% H₂O₂ to form the peroxy acid. Acetic acid, 25 ml, was then dripped into this reactant. H₂O was then admixed with this reactant quantum sufficum to 1 liter. The pulp was introduced followed by a reaction time of 2 hours at ambient pressure at 100° C. The resultant microcrystalline cellulose was then filtered and washed with deionized water. The resultant cellulose cake was then added to a 0.5% sodium hydroxide solution at about 100° C. The cellulose was again filtered and washed with deionized water and dried at ambient temperatures.

The cellulose exhibited the following characteristics:

Degree of Polymerization:

237

L*ab(measured with a Minolta CR-321 Chroma meter)

90.5-0.5-5.5

### EXAMPLE 15

A one step hydrolysis and bleaching of wood pulp was performed on raw unbleached wood pulp having a L*.ab value of 67.2-5.7-19.5.

Sulfuric acid, 36 ml, was dripped into 21 ml of 50% H₂O₂ to form the peroxy acid. Acetic acid, 13 ml was then dripped into this reactant. H₂O was then admixed with this reactant quantum sufficum to 1 liter. The pulp was introduced followed by a reaction time of 2 hours at ambient pressure at 100° C. wherein the temperature dropped below 100° C. for 1 hour. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

254

L*ab(measured with a Minolta CR-321 Chroma meter)

88.4-1.1-8.1

### EXAMPLE 16

A one step hydrolysis and bleaching of wood pulp was performed on Northern Bleached Softwood Kraft (NBSK) pulp having a L*ab value of 95.5-0.4-2.4.

H₂O was admixed with 170 ml hydrochloric acid quantum sufficum to 1 liter. The pulp was introduced followed by a reaction time of 2 hours at ambient pressure at 100° C. wherein the temperature dropped below 100° C. for 1 hour. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

227

L*ab(measured with a Minolta CR-321 Chroma meter)

92.8-0.8-2.3

### EXAMPLE 17

A one step hydrolysis and bleaching of wood pulp was performed on NBSK pulp having a L*ab value of 95.5-0.4-2.4.

72 ml of sulfuric acid was dripped into 42 ml of 50% H₂O₂ to form the peroxy acid. H₂O was then addmixed with this reactant quantum sufficum to 1 liter. The pulp was introduced followed by a reaction time of 2 hours at ambient pressure at 100° C. wherein the temperature dropped below 100° C. for 1 hour. The resultant microcrystalline cellulose was then filtered and washed with deionized water. The resultant cellulose cake was then added to a 1% sodium hydroxide solution at about 100° C. The cellulose was again filtered and washed with deionized water and dried at ambient temperatures.

The cellulose exhibited the following characteristics:

Degree of Polymerization:

208

L*ab(measured with a Minolta CR-321 Chroma meter)

94.6-0.1-2.2

It is noted that Example 16 was performed without peroxy acid and Example 17 was performed with peroxy acid. Example 17 had a brighter final product as compared to the final product of Example 16. This demonstrates that there was bleaching with peroxy acid, even with a pulp starting material with a high L* value (95.5).

The fact that the final product actually had a slightly lower L* value than the starting material may be due to variances in colorimeter readings with respect to various physical forms of the cellulose and their corresponding surface characteristics. For example, the starting material was in sheet form and the final product was in dried cake form.

What is claimed is:

1. A process for the production of microcrystalline cellulose comprising
hydrolyzing pulp with a sufficient amount of active oxygen in an acidic environment in a one step process; and
recovering the microcrystalline cellulose;
wherein said recovered microcrystalline cellulose has a color lightness (L*) greater than the color lightness (L*) of the pulp starting material.

2. The process according to claim 1 wherein said active oxygen is derived from a peroxy acid

3. The process according to claim 2 wherein said peroxy acid is peroxymonosulphuric acid.

4. The process according to claim 2 wherein said peroxy acid is formed prior to the one step process by reacting a sufficient amount of an acid with a sufficient amount of a peroxide.

5. The process according to claim 4 wherein said acid is sulfuric acid and said peroxide is hydrogen peroxide.

6. The process of claim 4 wherein said acid is selected from the group consisting of a mineral acid, a carboxylic acid and mixtures thereof.

7. The process of claim 6 wherein said carboxylic acid is acetic acid.

8. The process according to claim 1 wherein said active oxygen is derived from a member of the group consisting of oxygen, ozone, organic peroxides, hydroperoxides, peroxyacids, and peroxyesters.

9. The process according to claim 8 wherein said active oxygen is derived from a member of the group consisting of benzoyl peroxide, oxaloyl peroxide, lauroyl peroxide, acetyl peroxide, t-butyl peroxide, t-butyl peracetate, t-butyl peroxy pivalate, cumene hydroperoxide, dicumyl peroxide, 2-methyl pentanoyl peroxide and hydrogen peroxide.

10. The process according to claim 1 wherein said acidic environment is provided by a mineral acid, an organic acid or mixtures thereof.

11. The process according to claim 10 wherein said mineral acid is selected from the group consisting of hydrochloric acid, sulfuric acid, phosphoric acid, nitric acid, boric acid and mixtures thereof.

12. The process according to claim 10 wherein said organic acid is a carboxylic acid.

13. The process according to claim 12 wherein said carboxylic acid is selected from the group consisting of formic acid, acetic acid, oxalic acid and mixtures thereof.

14. The process according to claim 1 wherein said hydrolysis is conducted under heated conditions.

15. The process according to claim 10 wherein said hydrolyzing occurs at a pH of less than about 5.

16. The process according to claim 1 wherein the color lightness (L*) of the pulp is less than 70 and the color lightness (L*) of the microcrystalline cellulose is greater than 90.

17 The process according to claim 1 wherein the green to red color value (a) of the pulp is greater than 1 and the green to red color value (a) of the microcrystalline cellulose is between −0.5 and 0.5.

18. The process according to claim 17 wherein the green to red color value (a) of the pulp is greater than 2 and the green to red color value (a) of the microcrystalline cellulose is between −1 and 1.

19. The process according to claim 1 wherein the blue to yellow color value (b) of the pulp is greater than 10 and a blue to yellow color value (b) of the microcrystalline cellulose is less than 10.

20. The process according to claim 19 wherein said microcrystalline cellulose has a blue to yellow color value (b) of between −5 and 5.

21. The process according to claim 20 wherein said microcrystalline cellulose has a blue to yellow color value (b) of between −2.5 and 2.5.

22. The process according to claim 1 wherein the degree of polymerization for the microcrystalline cellulose is below about 350.

23. The process according to claim 22 wherein the degree of polymerization for the microcrystalline cellulose is below about 250.

24. The process according to claim 23 wherein the degree of polymerization for the microcrystalline cellulose is below about 100.

25. The process according to claim 1 wherein the color lightness (L*) of the pulp is less than 80 and the color lightness (L*) of the microcrystalline cellulose is greater than 85.

26. The process according to claim 1 wherein the color lightness (L*) of the pulp is less than 70.

27. The process according to claim 1 wherein the color lightness (L*) of the pulp is less than 80.

28. The process according to claim 1 wherein the color lightness (L*) of the pulp is less than 90.

29. The process according to claim 1 wherein the color lightness (L*) of the pulp is less than about 93

30. A composition comprising microcrystalline cellulose produced by a process comprising
hydrolyzing pulp with a sufficient amount of active oxygen in an acidic environment in a one step process; and
recovering the microcrystalline cellulose;
wherein said recovered microcrystalline cellulose has a color lightness (L*) greater than the color lightness (L*) of the pulp starting material.

31. The composition according to claim 30 wherein said active oxygen is derived from a peroxy acid.

32. The composition according to claim 30 wherein said peroxy acid is peroxymonosulphuric acid.

33. The composition according to claim 30 wherein said peroxy acid is formed prior to the one step process by reacting a sufficient amount of an acid with a sufficient amount of a peroxide.
